(19) United States
(12) Patent Application Publication
(10) Pub. No.: US 2010/0125471 A1
(43) Pub. Date: May 20, 2010

(54) FINANCIAL JOURNALS IN FINANCIAL MODELS OF PERFORMANCE SERVERS

(75) Inventors: Jin Wang, Kirkland, WA (US); Scott Sebelsky, Camano Island, WA (US); Luming Wang, Bellevue, WA (US); Patricia O. Sebelsky, Camano Island, WA (US); Malik Hussain, Woodinville, WA (US); Sridharan V. Ramanathan, Kirkland, WA (US); Zhenyu Tang, Sammamish, WA (US); Rou-Peng Huang, Woodinville, WA (US); Mark Xiaohong Yang, Sammamish, WA (US); Patrick J. Baumgartner, Kirkland, WA (US); Peter Eberhardy, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/272,688

(22) Filed: Nov. 17, 2008

(51) Int. Cl. G06F 17/50; G06Q 40/00

(52) U.S. Cl. 705/7; 705/35

(57) ABSTRACT

Architecture that employs a journal assignment that can be created on demand when journal is created, and operates outside the business cycle. The assignment is routed to reviewers and approvers based on predefined company policy that users define. The assignment encloses a changelist of data changes created by the journal. The changelist is used for rendition and calculation for reviewers and approvers (in addition to the journal contributor) to view/verify and modify the data as if the data is already written into the model. At the time that other users access this model, the data is not present. At the end of the successful workflow chain the changelist is written into the model. If failed, the changelist will be used as that basis for correction or the user can discard the changelist.

### BACKGROUND

Workflow management systems are computing systems that provide functionality for modeling business processes, along with the ability to implement and monitor the procedural and computational aspects of each process. For example, a corporation may utilize a workflow management system to model a business process for generating a rolling forecast of sales generated by the organization. As part of the modeling process, the employees of the corporation that submit data as a part of the process are identified, as are the supervisors that are responsible for approving or rejecting the data submitted by the employees.

Assignments are work activities that are defined within each workflow business cycle. An assignment may be made to a single user or a group of users. A data entry form may also be associated with an assignment. For example, an assignment may request that a user provide a sales figure using a specified data entry form. Because assignments belong to cycles, different instances of the same assignment can be created for different cycles. Assignments may also contain properties specifying an approval chain or other validation rules that a data submission associated with the assignment must pass through for the assignment to be completed.

Jobs may also be generated by services executing within the workflow system as part of a cycle or assignment. For instance, a scheduled job service may execute within the system for launching jobs according to a schedule. As an example, a job may be instantiated periodically for reprocessing the contents of a database, such as the online analytical processing (OLAP) database.

In many enterprise corporations during a legal consolidation, companies insist on having a financial journaling capability in order to help facilitate the proper close of the business cycle, in accordance with Sarbanes-Oxley compliance, for example. However, these current systems can be limiting in capabilities.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates the creation of a journal in a financial model. To address the workflow requirements of financial journals, the architecture employs journal assignments that can be created on demand when journal is created, and which assignments operate outside the business cycle. An assignment can be routed to reviewers and approvers based on a predefined company policy that users define. The assignment encloses a changelist of data changes created by the journal. The changelist is used for rendition and calculation for reviewers and approvers (in addition to the journal contributor) to view/verify and modify the data as if the data is already written into the model. At the time that other users access this model, the data is not present. At the end of the successful workflow chain the changelist is written into the model. If failed, the changelist will be used as that basis for correction or the user can discard the changelist.

On the modeling side, a journal dimension is added to facilitate the audit-ability of the journal entry. When the journal changelist is written into the model, a journal ID is added as a member of this dimension. The dimension enables the unposting and reversing of the journal easily and efficiently. The dimension also enables the auditing and monitoring of the journal entry using standard OLAP/SQL reporting tools. Furthermore, the journal credit and debit are implemented as calculated measures as a function of the account type.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented workflow system in accordance with the disclosed architecture.

FIG. 2 illustrates a more detailed workflow system that employs policies for review and approval processing.

FIG. 3 illustrates an exemplary journal reviewer hierarchy for a selected memberset.

FIG. 4 illustrates a workflow method in accordance with the disclosed architecture.

FIG. 5 illustrates a method of running jobs based on journal approval.

FIG. 6 illustrates a method of using workflow processes in a financial model having financial journals.

FIG. 7 illustrates a block diagram of a computing system operable to implement financial journals in models in accordance with the disclosed architecture.

FIG. 8 illustrates a schematic block diagram of a computing environment for processing models with financial journals.

### DETAILED DESCRIPTION

The disclosed architecture adds a journal dimension to a financial model for journal processing outside of normal workflow cycles. The architecture creates special journal assignments in a performance management server, for example, that can be routed to reviewers and approvers based on corporate policies.

A journal dimension is a predefined dimension that can be optionally added to a financial model. A journal assignment is a special type of assignment. When selecting to include journals in the model, the journal dimension member includes at least one entry. This can contain zero to many journal line items. This assignment applies to exactly one member in the journal dimension. A journal assignment is what most people refer to as a journal. The journal assignment form would have two columns for values (debit and credit) for financial journals. Journal line items are zero to many fact rows that are associated with a journal assignment.

A journal is a more than data entry or a line item. The business user is provided a way to make adjustments to local reporting entity data in both local currency and also in the consolidated currency, for example. These journals can be named and support many line items in each journal entry. A detailed workflow process (e.g., submit, review, approve, post, unpost, reverse, etc.) provides an audit trail for each step of the journal process.

Journal fact data optionally can be seen by any user until the data has been posted in the workflow system. Unposted journal data can be used to perform a “what if” scenario for consolidations prior to writeback. Moreover, journals can go through a customized validation process (e.g., the journal can be balanced before review submission). The financial journals are ad hoc in nature and are not required to go through the regular assignment process.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

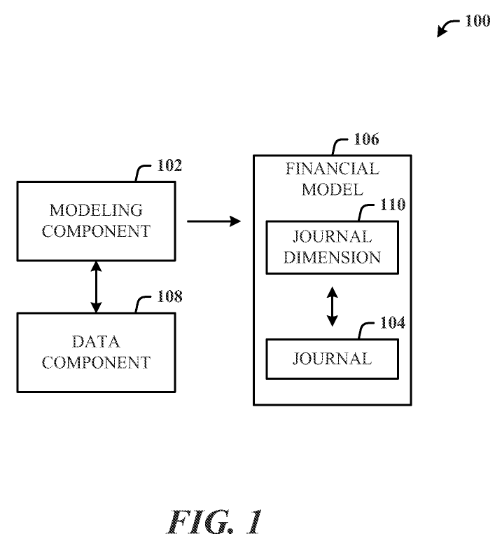

FIG. 1 illustrates a computer-implemented workflow system 100 in accordance with the disclosed architecture. The system 100 includes a modeling component 102 for creating a journal 104 in association with a financial model 106. A data component 108 is provided for processing the journal 104 as an assignment associated with the financial model 106.

The dimension 110 enables the unposting and reversing of the journal easily and efficiently. The dimension 110 also enables the auditing and monitoring of the journal entry using standard OLAP (online analytical processing)/SQL (structured query language) reporting tools.

The journal dimension 110 is generated when the model 106 is deployed. The dimension 110 includes journal identifiers (IDs) as members. The member is created and added when the journal 104 is created. Only the dimension needs to be incrementally processed, and thus, incurs a minimal performance penalty. The security for the new member can be initially set to limit read permission to the journal author only. After the submission, the security can be expanded to all reviewers/approvers. After the journal is posted, the security can be further expanded to include other people

The journal dimension 110 sets the foundation for auditability of the journal entry, since the journal entry will not interfere with normal journal entries. The journal IDs are unique and cannot be double posted or reused.

The journal dimension 110 also ensures easy and efficient implementation of unposting and reversing of a journal. The unposting process is now a simple matter of deleting all the entries in that journal slice, and reversing is simply a copy of all the rows in the slice and then flipping the sign. An aggregation engine of the OLAP service will then cancel the entries out.

The journal dimension 110 also enables drill-down and drill-up on the journal entry with existing OLAP reporting mechanism or tools. This added journal dimension 110 is also used by a writeback module to ensure data security and to ensure each journal can only write into its own slice.

For the journal model 106, a credit measure and a debit measure are also generated. However, the measures are implemented as calculated measures and calculated based on the fact data and the account type. This implementation maintains the data integrity of the fact data, which still provides the convenience of the debit and credit view. Since all three measures are visible in the model, any OLAP client can choose either a single column fact view or a two column credit and debit view. Furthermore, metadata are enhanced so that the writeback code on the client can easily decide the proper sign for sending the data back to the fact from debit and credits.

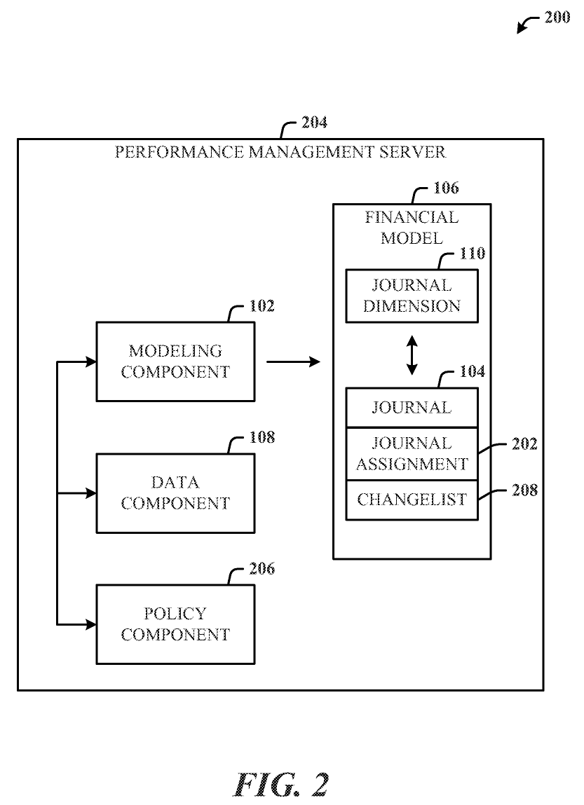

FIG. 2 illustrates a more detailed workflow system 200 that employs policies for review and approval processing. The journal 104 can be implemented as special type of assignment 202, such as can be employed in a performance management server 204, for example. However, the journal assignment 202 does not belong to any workflow cycles, but rather is associated with financial models. The workflow related properties are derived from properties of the model 106. A policy component 206 can be provided that includes policies one of which can be utilized for choosing the reviewer(s) and approver(s) and which can be determined from the model 106 or parent(s) of model 106.

The journal assignment 202 can include a changelist 208 of changes for review, approval, rejection, and other processes without actual writeback into the final model (typically stored on backend system(s)). Thus, users who use the model 106 directly will not see the changes. On the other hand, for users involved with the journal assignment 202 the changes can be applied such that the model 106 behaves as a virtual financial model for testing or “what if” purposes, of example. These users can view the virtual model as if the writeback has occurred. In other words, the model can be exercised at the middle tier rather than the backend.

As described above, the changelist 208 can be shared by all users involved in the assignment 202 (to users requested to provide financial data). The assignment 202 can also be shared by a broader set of users, if desired. Only after approval and validation will the changelist 208 be written to the final model. Thereafter, the changelist 208 only serves the purpose for auditing or can then be deleted.

The switch of the state of the changelist 208 can be determined by the status of the journal assignment 202 workflow. Thus, journals can be created using existing APIs, of the performance management server 204, for example, for ad hoc assignment creation. However, since there is no automatic journal assignment creation from a recurrent cycle as regular assignments, the journals can be created on demand.

In other words, the modeling component 102 facilitates adding the dimension 110 to the model 106 that maps to the journal 104. The assignment 202 can be created when the journal 104 is created. The assignment 202 includes the changelist 208 of changes to financial data of the model 106. The modeling component 102 facilitates adding the journal dimension 110 to the financial model 106, the dimension 110 employed for auditability, unposting, and reversing. The modeling component 102 also facilitates creation of a credit measure and a debit measure in association with the journal 104, both of which are calculated based on account type. The journal 104 facilitates the creation of the virtual financial model 106 where the journal entry can be modified by users in a workflow chain prior to final approval and writeback to the financial model. The policy component 206 facilitates routing of the assignment 202 for review and approval based on a predefined policy.

In the workflow system 200, the modeling component 102 can create the financial model 106 having the journal dimension 110, the dimension 110 having the journal assignment 202 associated therewith. The data component 108 includes the changelist 208 of data changes in the assignment 202. The policy component 206 facilitates routing of the assignment 202 for review and approval based on a predefined policy, the assignment 202 modified by users in a workflow chain prior to final approval and writeback to a database.

The assignment 202 can be created when the journal 104 is created, and the journal assignment 202 can be balanced or unbalanced. The dimension 110 can be employed for auditability, unposting, and reversing. The modeling component 102 creates a credit measure and a debit measure, both of which are calculated based on account type.

In response to receiving the assignment 202, a user may generate data that will be stored in the fact table and the OLAP database. For instance, a user may utilize a client application, such as a spreadsheet application program, to generate the requested data. In one implementation, this data is represented as an extensible markup language (XML) changelist that includes data describing how the generated data will be stored within the fact table (final rendition of the data when posted) and the OLAP database. It is to be appreciated, however, that the changelist 208 may comprise any type of package or document format. The changelist 208 may also be compressed and/or encrypted to allow more efficient and secure network transmission. In addition to the changelist 208, the client application may also submit one or more documents that support the contents of the changelist 208. For instance, a spreadsheet document that includes the underlying computations utilized to arrive at the contents of the changelist 208 may be submitted. A backend service executing within the workflow management system can verify the contents of the supporting documents and store the documents in an appropriate database or document library within the workflow management system.

Following is an example of creating a journal. First, the user is validated for the security rights to create a journal. A journal assignment keeps track of the following information: Created by, Create Time, Reviewed by, Reviewed Time, Approved by, Approved Date. If auto-labeling for journals is enabled, the journal label is auto-generated when creating the journal. The ability to attach multiple documents or varying types (e.g., spreadsheet or word processing documents) to the assignment is allowed. The user can select the balancing property (e.g., balanced, unbalanced) of the journal. The user can also select the journal type (e.g., financial).

The user can then enter the line items for this journal assignment. Journal line items are appended, and not overwritten like a data entry. The sequence of the line items entered is maintained. Journal line items keep track of credits and debits with their amounts. The deletion of journal line items is supported as well.

The journal can be submitted for review or approval. During the submission process a check can be made (depending upon the balancing property) to ensure that the total debits and total credits are the same before the data can be written to the database. If a model property “Defer Journal Submission Writes”, for example, is set to TRUE then the data is to be left in the changelist until the final approval step. If this is the final approval step or “Defer Journal Submission Writes” is set to FALSE, then the Journal Status can be set to “Posted”. The data in the changelist is then written to the main fact database.

The disclosed workflow process can include rejection of the assignment. First, a check is made to ensure that the user has the proper security to reject the journal assignment. If the status of the journal was “Posted” then all of the rows in the fact table for this journal are deleted. The journal status is then set back to “Unposted”. The workflow status is then set to “Rejected”.

The disclosed workflow process can include reversal of the assignment. First, a check is made to ensure that the user has the proper security to Reverse the journal (e.g., as a journal administrator). The journal status is validated as “Posted”. The cells of the journal line items are written with negated values to the main fact table. The journal submission status is set to “Reversed”. No further modifications can be made to this journal.

The disclosed workflow process can include purging of the journal assignment. First, a check is made to ensure that the user is a journal administrator for this model. If the status of the journal was “Posted”, then all of the rows in the fact table for this journal can be deleted, and the journal assignment purged. Thereafter, the journal member can be deleted from the journal dimension that is associated with this journal assignment.

The user can generate an operational report, and also apply filtering criteria to use in generating an operational report. Additionally, the loading/extracting of journals can be performed.

Model-to-model mapping is provided. When mapping from one model to another, the journal assignments are treated in a similar manner as other assignments.

After all of the journals have been approved for a scenario and period, the controller can run the jobs. The jobs include an intercompany reconciliation job, currency conversion job, consolidation job, to name just a few.

As previously indicated, when the user creates a model, an option is provided to enable journals for the model. If the user does not enable journals in the model, then the user cannot perform journals. The order of the line items is maintained. That is to say that if the first row corresponds to an account Cash and the second row is for account AcctPayable, this ordering is maintained with the journal. It is valid for a journal assignment not to have any associated journal line items. Since, in most cases, the fact data for a journal does not write to the database until the final approval is completed, there is an option on the assignment that allows for this.

With respect to debit and credit, when computing the sign of the value to be put into the changelist and stored in the database, the rules for storing debits/credits for all journal types except non-financial types, are the following. When entering a debit or credit in a journal, the user indicates a corresponding desire to increase or decrease the account balance.

Accounts that have a debit/credit property={Debit, Credit} are valid. If the journal contains other accounts that are not either Debit or Credit, an error is presented. The client only shows accounts that have the DebitCredit property of {Debit, Credit}. A debit value increases accounts that have the DebitCredit property={Debit}. A credit value decreases accounts that have the DebitCredit property={Debit}. A debit value decreases accounts that have the DebitCredit property={Credit}. A credit value increases accounts that have the DebitCredit property={Credit}.

Following are examples that illustrate the debit/credit measurements for journals.

### EXAMPLE 1

Journal A submits a 100 credit for account Fixed Assets which is of type Asset. Since account type Asset has a debit/credit property of debit, the data is stored as −100.

### EXAMPLE 2

Journal A submits a 100 debit for account Fixed Assets which is of type Asset. Since account type Asset has a debit/credit property of debit, the data is stored as 100.

### EXAMPLE 3

Journal A submits a −100 credit for account Fixed Assets which is of type Asset. Since account type Asset has a debit/credit property of debit, the data is stored as 100.

### EXAMPLE 4

Journal A submits a −100 debit for account Fixed Assets which is of type Asset. Since account type Asset has a debit/credit property of debit, the data is stored as −100.

### EXAMPLE 5

Journal A submits a 100 credit for account Revenue which is of type Income. Since account type Income has a debit/credit property of credit, the data is stored as 100.

In order to facilitate journal data entry, a journal data entry form can be provided. Differences between journal data entry form and a standard data entry form are the following: a standard data entry form usually uses a default Value measure, while a journal data entry form uses two calculated measures (Debit and Credit).

Model properties created in support of journals include defer journal submission writes (if TRUE, do not write the fact data associated with this journal to the main fact table until final approval), journal reviewers (memberset from user dimension that defines which reviewer(s) are stipulated for which contributors), journal approvers (memberset from user dimension that defines which approver(s) are stipulated for which contributors), and allow reviewer/approver to edit journal submissions.

Because the journal assignment is being created in a spreadsheet application, for example, the assignment can specify the submission hierarchy. In order to handle this automatically during the creation of the assignment, the following work rules apply. Only the immediate parent(s) reviews/approves the journal. Grandparents and above are not considered as reviewers/approvers. In the event that the parent is a group, then only one member of the group is needed to review/approve the journal. If the user belongs to multiple groups and as a result has multiple immediate parents in the memberset, then each immediate parent (if the parent is a group, then only one member of the group is required) reviews/approves the journal. If the user is not in any group or specified as a user in the memberset, then this step in the reviewer or approver workflow is skipped.

An alternate embodiment can employ journal versioning separately or in combination with previous embodiments. Journal versioning enables the preservation of the changes made to a journal by same or different users throughout the life of the journal. Reports can then be generated on all changes and dissected for auditing and compliance purposes, such as in accordance with the Sarbanes-Oxley Act, for example.

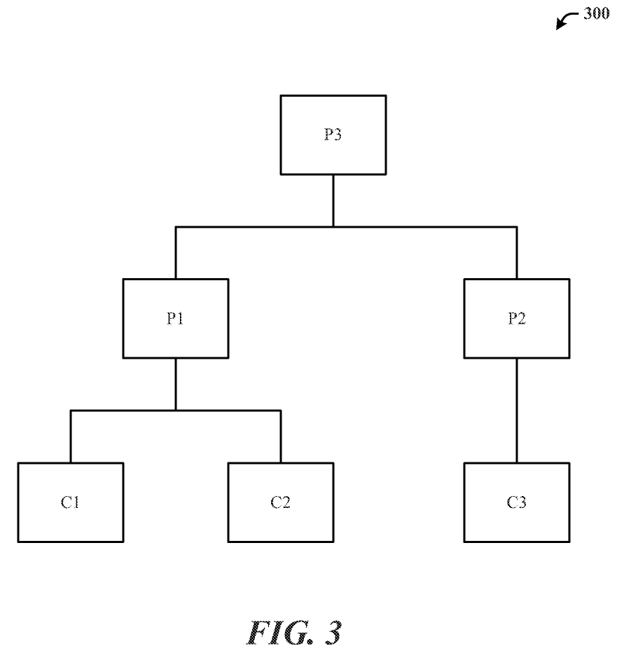

FIG. 3 illustrates an exemplary journal reviewer hierarchy 300 for a selected memberset. Note that C1, C2, C3, P1, P2 or P3 can either be an individual user or a group.

### EXAMPLE 1

All boxes in the hierarchy 300 represent users, not groups. Here, user C1 creates the journal assignment. User P1 reviews the journal before going on to the approval step.

### EXAMPLE 2

All boxes in the hierarchy 300 represent users, not groups, except P1 is a group. User C1 creates the journal assignment. A user in group P1 reviews the journal before going on to the approval step.

### EXAMPLE 3

All boxes in the hierarchy 300 represent groups. Consider that a user C4 belongs to groups C1 and C3. A user in group P1 reviews the journal and a user in group P2 reviews the journal before going on to the approval step.

### EXAMPLE 4

All boxes in the hierarchy 300 represent groups. Consider that a user C4 belongs to group P1. A user in group P3 reviews the journal before going on to the approval step.

### EXAMPLE 5

All boxes in the hierarchy 300 represent groups. Consider that a user C4 belongs to group P1. A user in group P3 reviews the journal before going on to the approval step.

### EXAMPLE 6

All boxes in the hierarchy 300 represent groups. Consider that a user C4 belongs to group P3. Since there is no parent to P3, this journal skips the reviewer step and goes immediately to the approval step.

### EXAMPLE 7

All boxes in the hierarchy 300 represent groups. Consider that a user C4 does not belong to any group. Since C4 is not in any of the above groups, this journal skips the reviewer step and goes immediately to the approval step.

The server provides a list of assignment creation properties and valid values to the client (similar to job properties). The journal assignment is created outside of the normal workflow cycles. The user creating the assignment sends all of the properties of a journal. The user adds a new journal member and assigns the journal member to the model specific memberset. If a journal label or journal assignment already exists for this label, then an error is generated.

A journal is balanced when the total debits equal total credit. Balance can be by currency, period, and scenario, for example. It is acceptable for journal line items to use different business process members. If there is data in both the debit and credit columns, the data is treated for balancing purposes as if there were two journal line items entered (e.g., if for the same cell there was a Debit=30 and Credit=10, then it is the same as a net Debit of 20).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

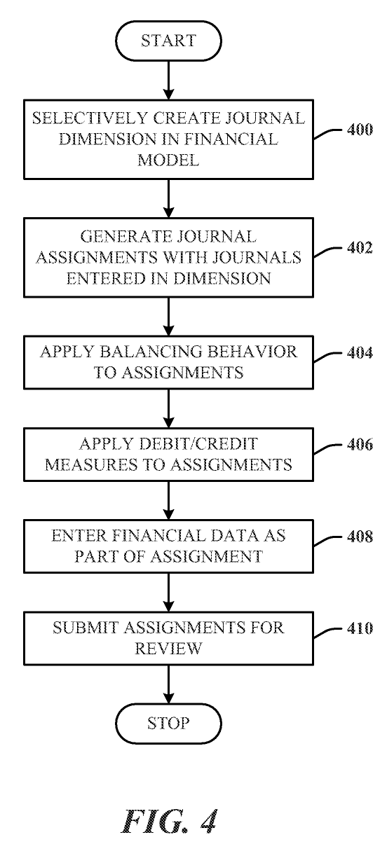

FIG. 4 illustrates a workflow method in accordance with the disclosed architecture. At 400, a journal dimension is selectively created in a financial model. This is an optional selection for the user. At 402, journal assignments are generated in association with journals entered in the dimension. At 404, balancing behavior is applied to the assignments. At 406, debit and credit measures are applied to the assignments. At 408, financial data is entered as part of the assignments. At 410, the assignments are submitted for review.

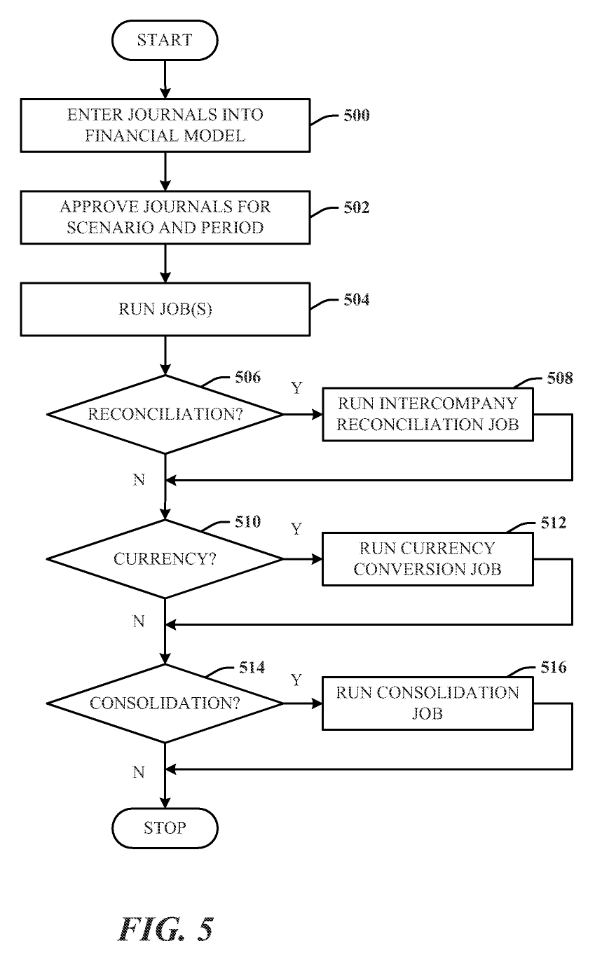

FIG. 5 illustrates a method of running jobs based on journal approval. At 500, journals are entered into a financial model. At 502, after all journals have been approved for a scenario and period, a controller can run the jobs, as indicated at 504. At 506, the controller can choose to initiate a reconciliation job. Flow is then to 508 to run an intercompany reconciliation job. If the controller chooses not to perform reconciliation, flow is to 510 to optionally run currency conversion. If so, flow is to 512 to run a currency conversion job. If the controller chooses not to perform conversion, flow is to 514 to perform consolidation. If so, flow is to 516 to run a consolidation job.

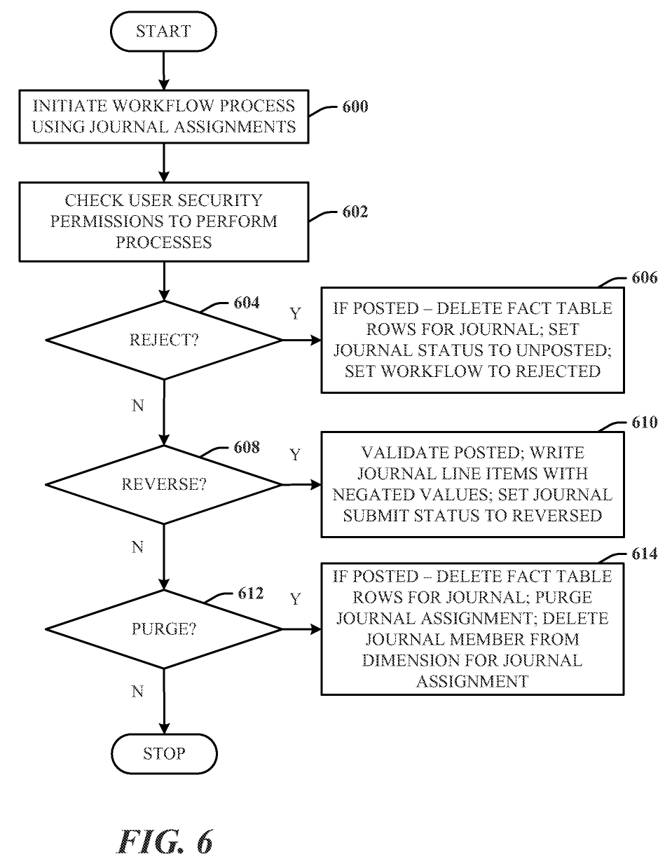

FIG. 6 illustrates a method of using workflow processes in a financial model having financial journals. At 600, a workflow process is initiated using journal assignments. At 602, user security is checked to ensure that the user is permitted to work with journal assignments and the model. At 604, the user can choose to reject a journal assignment. At 606, if the status of the journal was “Posted” then all of the rows in the fact table for this journal are deleted. The journal status is then set back to “Unposted”, and the workflow status is then set to “Rejected”.

Alternatively, the user can choose to perform an assignment reversal process, as indicated in flow from 604 to 608. At 610, the journal status is validated as “Posted”. The cells of the journal line items are written with negated values to the main fact table, and the journal submission status is set to “Reversed”. No further modifications can be made to this journal.

Alternatively, the user can choose to perform purging of the journal assignment, as indicated in flow from 608 to 612. At 614, if the status of the journal was “Posted”, then all of the rows in the fact table for this journal can be deleted, and the journal assignment purged. Thereafter, the journal member can be deleted from the journal dimension that is associated with this journal assignment.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

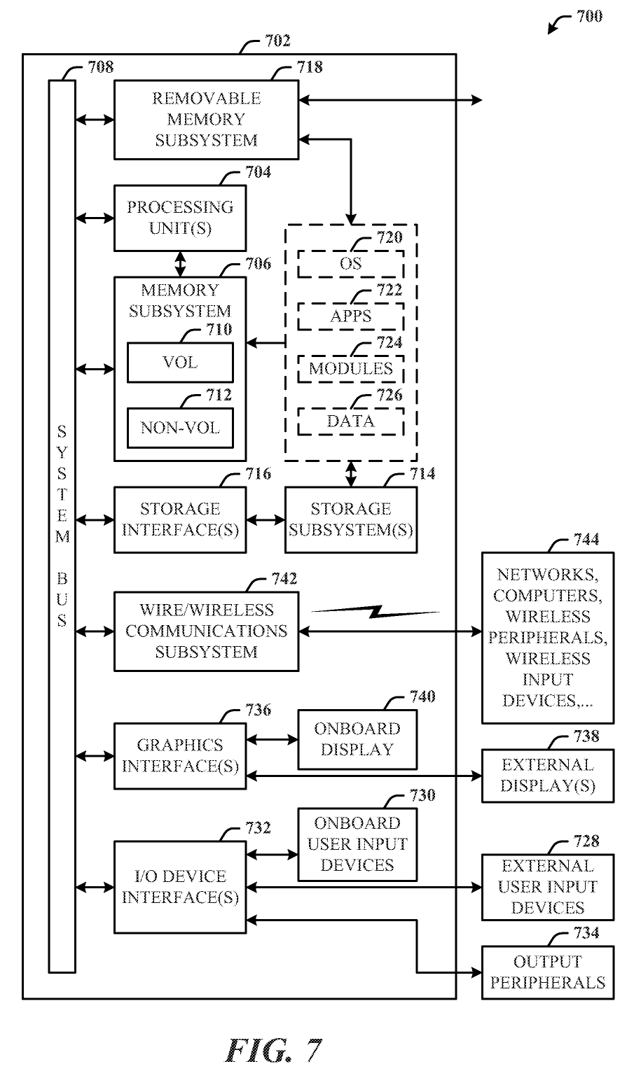

Referring now to FIG. 7, there is illustrated a block diagram of a computing system 700 operable to implement financial journals in models in accordance with the disclosed architecture. In order to provide additional context for various aspects thereof, FIG. 7 and the following discussion are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 706 can include volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the memory subsystem 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes storage subsystem(s) 714 and storage interface(s) 716 for interfacing the storage subsystem(s) 714 to the system bus 708 and other desired computer components. The storage subsystem(s) 714 can include one or more of a hard disk drive (HDD), a magnetic floppy disk drive (FDD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a removable memory subsystem 718 (e.g., flash drive form factor technology), and/or the storage subsystem(s) 714, including an operating system 720, one or more application programs 722, other program modules 724, and program data 726. Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Computer readable media can be any available media that can be accessed by the computer 702 and includes volatile and non-volatile media, removable and non-removable media. For the computer 702, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 702, programs, and data using external user input devices 728 such as a keyboard and a mouse. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example. These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP) using logical connections via a wire/wireless communications subsystem 742 to one or more networks and/or other computers. The other computers can include workstations, servers, routers, personal computers, microprocessor-based entertainment appliance, a peer device or other common network node, and typically include many or all of the elements described relative to the computer 702. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wire/wireless communication subsystem 742 (e.g., a network interface adapter, onboard transceiver subsystem, etc.) to communicate with wire/wireless networks, wire/wireless printers, wire/wireless input devices 744, and so on. The computer 702 can include a modem or has other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

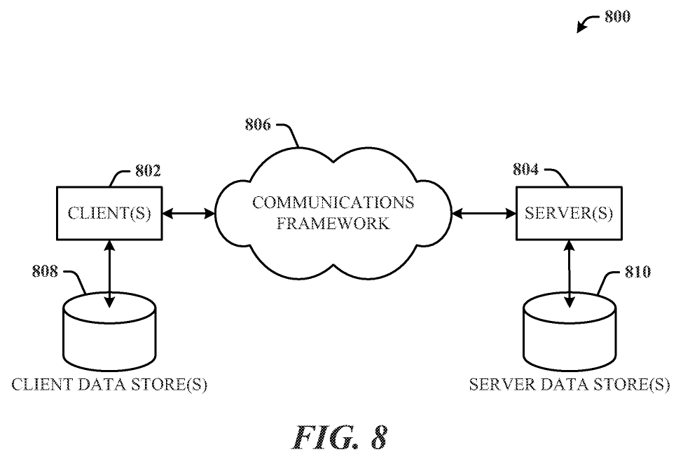

Referring now to FIG. 8, there is illustrated a schematic block diagram of a computing environment 800 for processing models with financial journals. The environment 800 includes one or more client(s) 802. The client(s) 802 can be hardware and/or software (e.g., threads, processes, computing devices). The client(s) 802 can house cookie(s) and/or associated contextual information, for example.

The environment 800 also includes one or more server(s) 804. The server(s) 804 can also be hardware and/or software (e.g., threads, processes, computing devices). The servers 804 can house threads to perform transformations by employing the architecture, for example. One possible communication between a client 802 and a server 804 can be in the form of a data packet adapted to be transmitted between two or more computer processes. The data packet may include a cookie and/or associated contextual information, for example. The environment 800 includes a communication framework 806 (e.g., a global communication network such as the Internet) that can be employed to facilitate communications between the client(s) 802 and the server(s) 804.

Communications can be facilitated via a wire (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804. The server(s) 804 can include the system 100 of FIG. 1, system 200 of FIG. 2, the policies hierarchy example of FIG. 3, and methods 4-6, for example.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented workflow system, comprising:
a modeling component for creating a journal in association with a financial model; and
a data component for processing the journal as an assignment associated with the financial model.

2. The system of claim 1, wherein the modeling component facilitates adding a dimension to the model that maps to the journal.

3. The system of claim 1, wherein the assignment is created when the journal is created.

4. The system of claim 1, wherein the assignment includes a changelist of changes to financial data of the model.

5. The system of claim 1, wherein the modeling component facilitates adding a journal dimension to the financial model, the dimension employed for auditability, unposting and reversing.

6. The system of claim 1, wherein the modeling component facilitates creation of a credit measure and a debit measure in association with the journal, both of which are calculated based on account type.

7. The system of claim 1, wherein the journal facilitates creation of a virtual financial model where the journal entry can be modified by users in a workflow chain prior to final approval and writeback to the financial model.

8. The system of claim 1, further comprising a policy component for routing the assignment for review and approval based on a predefined policy.

9. A computer-implemented workflow system for performance management, comprising:
a modeling component for creating a financial model having a journal dimension, the dimension having a journal assignment associated therewith;
a data component for including a changelist of data changes in the assignment; and
a policy component that routes the assignment for review and approval based on a predefined policy, the assignment modified by users in a workflow chain prior to final approval and writeback to a database.

10. The system of claim 9, wherein the assignment is created when the journal is created, and the journal assignment is balanced or unbalanced.

11. The system of claim 9, wherein the dimension is employed for auditability, unposting, and reversing.

12. The system of claim 9, wherein the modeling component creates a credit measure and a debit measure, both of which are calculated based on account type.

13. A computer-implemented workflow method, comprising:
selectively creating a journal dimension in a financial model;
generating journal assignments in association with journals entered in the dimension;
applying balancing behavior to the assignments;
applying debit and credit measures to the assignments;
entering financial data as part of the assignments; and
submitting the assignments for review.

14. The method of claim 13, further comprising routing the assignments for approval before writeback to a database.

15. The method of claim 13, wherein the debit and credit measures are based on fact data and account type.

16. The method of claim 13, further comprising processing the financial data of the assignment using calculations, conversions, consolidations, and reconciliations.

17. The method of claim 13, further comprising posting and unposting a journal.

18. The method of claim 13, further comprising reversing a posted journal.

19. The method of claim 13, further comprising attaching documents of different types to the assignments.

20. The method of claim 13, further comprising processing the financial data outside of a workflow cycle.
